(19) United States
(12) Patent Application Publication
(10) Pub. No.: US 2023/0206299 A1
(43) Pub. Date: Jun. 29, 2023

(54) SYSTEM AND METHOD FOR VISUAL COMPARISON OF FASHION PRODUCTS

(71) Applicant: Myntra Designs Private Limited, Bangalore (IN)

(72) Inventors: Konduru Saiswaroop, Wanaparthy (IN); Sreekanth Vempati, Hyderabad (IN); Sandeep Repakula, Kurnool (IN)

(21) Appl. No.: 17/719,914

(22) Filed: Apr. 13, 2022

(30) Foreign Application Priority Data
Dec. 24, 2021 (IN) 202141060730

(51) Int. Cl. G06Q 30/06; G06T 7/70; G06V 10/44; G06V 10/75

(52) U.S. Cl. CPC G06Q 30/0629; G06Q 30/0643; G06T 7/70; G06V 10/443; G06V 10/757

(57) ABSTRACT

A system and method for visually comparing one or more attributes of two fashion products on an e-commerce platform is presented. The system includes an image database, a selection module and a comparison module. The image database includes a plurality of two-dimensional (2D) images captured at the same scale for a plurality of fashion products. The selection module is configured to allow a user to select a target fashion product and a reference fashion product. The comparison module is configured to access a 2D image of the target fashion product and a 2D image of the reference fashion product from the image database; and allow the user to visually compare the target fashion product with the reference fashion product with respect to the one or more attributes by positioning the 2D image of the target fashion product on top or bottom of the 2D image of the reference fashion product.

### PRIORITY STATEMENT

The present application hereby claims priority to Indian Patent Application number 202141060730 filed on 24 Dec. 2021, the entire contents of which are hereby incorporated herein by reference.

### BACKGROUND

Embodiments of the present invention generally relate to systems and methods for visually comparing one or more attributes of two fashion products on an e-commerce platform, and more particularly to systems and methods for visually comparing size and/or fit-related attributes of two fashion products on an e-commerce platform.

Online shopping (e-commerce) platforms for fashion products, supported in a contemporary Internet environment, are well known. Shopping for fashion products online via the Internet is growing in popularity because it potentially offers shoppers a broader range of choices of fashion products in comparison to earlier off-line boutiques and superstores.

However, customers may not be able to decide on the correct size and/or fit to be purchased because of inaccurate and/or incomplete size chart information available on the e-commerce platforms. Further, there is a lack of standardization across different brands in terms of size labels. Thus, customers are not able to get an understanding of the size and fit of the product they are about to purchase against a reference product that fits them perfectly. The incorrect size and/or fit of products purchased may lead to returns in fashion e-commerce, thereby resulting in logistic costs and opportunity costs. The returns may also lead to unsatisfactory customer experience and erosion of trust in the e-commerce platforms.

Thus, there is a need for systems and methods that allow a user to compare the size and/or fit of fashion products purchased online via e-commerce platforms.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for visually comparing one or more attributes of two fashion products on an e-commerce platform is presented. The system includes an image database, a selection module and a comparison module. The image database includes a plurality of onal (2D) images captured at the same scale for a plurality of fashion products. The selection module is configured to allow a user to select a target fashion product and a reference fashion product. The comparison module is configured to access a 2D image of the target fashion product and a 2D image of the reference fashion product from the image database; and allow the user to visually compare the target fashion product with the reference fashion product with respect to the one or more attributes by positioning the 2D image of the target fashion product on top or bottom of the 2D image of the reference fashion product.

According to another example embodiment, a method for visually comparing one or more attributes of two fashion products on an e-commerce platform is presented. The method includes receiving an information corresponding to a target fashion product and a reference fashion product selected by a user; accessing a 2D image of the target fashion product and a 2D image of the reference fashion product from an image database comprising a plurality of two-dimensional (2D) images captured at the same scale for a plurality of fashion products; and allowing the user to visually compare the target fashion product with the reference fashion product with respect to the one or more attributes by positioning the 2D image of the target fashion product on top or bottom of the 2D image of the reference fashion product.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example system for visually comparing two fashion products on an e-commerce platform, according to some aspects of the present description,

FIG. 2 is a block diagram illustrating an example workflow for 2D image generation, according to some aspects of the present description,

FIG. 3A illustrates an example user interface for comparing two fashion products, according to some aspects of the present description,

FIG. 3B illustrates an example user interface for comparing two fashion products, according to some aspects of the present description,

FIG. 4 illustrates an example user interface for comparing two fashion products, according to some aspects of the present description,

FIG. 5 illustrates a flow chart for visually comparing two fashion products on an e-commerce platform, according to some aspects of the present description,

FIG. 6 illustrates a flow chart for generating 2D images at the same scale, according to some aspects of the present description, and

FIG. 7 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system’s registers and memories into other data similarly represented as physical quantities within the computer system memories or registers or other such information storage, transmission or display devices.

Example embodiments of the present description provide systems and methods for visually comparing one or more attributes of two fashion products on an e-commerce platform. Some embodiments of the present description provide systems and methods for visually comparing size and/or fit-related attributes of two fashion products on an e-commerce platform.

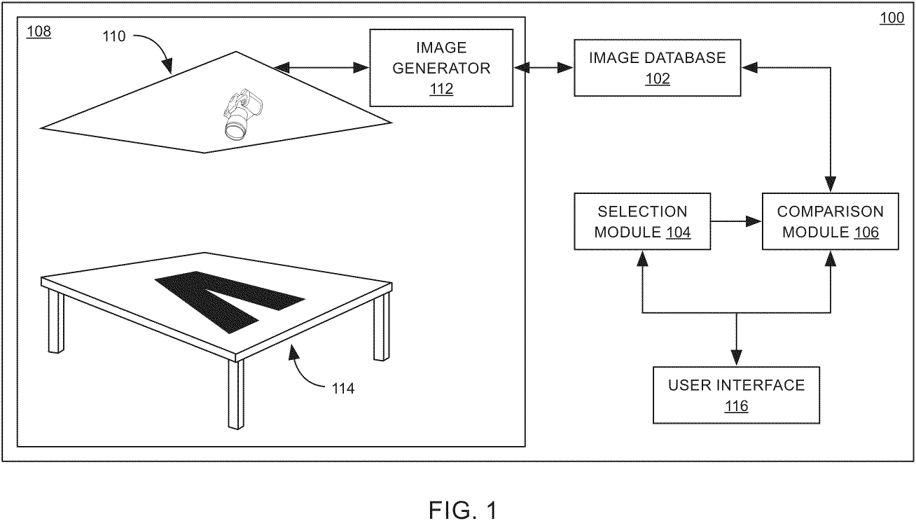

FIG. 1 illustrates an example system 100 for visually comparing one or more attributes of two fashion products on an e-commerce platform. The one or more attributes include size and/or fit-related attributes of the fashion product. Non-limiting examples of fashion products include garments (such as top wear, bottom wear, and the like), accessories (such as scarves, belts, socks, sunglasses, bags), jewelry, footwear, and the like. For the purpose of this description, the following embodiments are described with respect to an online fashion retail platform. However, it must be understood that embodiments described herein can be implemented on any e-commerce platform having a portfolio of fashion products.

Non-limiting examples of size-related attributes include length, width, area, circumference, and the like. For garment-related fashion products, non-limiting examples of size-related attributes may include, for example, length of the garment, length of a sleeve, waist size, width of a shoulder, length of an inseam, and the like. Embodiments of the present description facilitate visual online comparison of such attributes for two fashion products using the system 100 of FIG. 1.

The system 100 includes an image database 102, a selection module 104, and a comparison module 106. Each of these components is described in detail below.

The image database 102 includes a plurality of two-dimensional (2D) images captured at the same scale for a plurality of fashion products. The 2D images are standalone images of the fashion product in one embodiment. The term “standalone image” as used herein refers to the image of the fashion product by itself and does not include a model or a mannequin. In certain embodiments, the 2D images may be flat shot images of the fashion product. The flat shot images may be taken from any suitable angle and include top-views, side views, front-views, back-views, and the like.

As noted earlier, the 2D images are captured at the same scale. The system 100 further includes an image processing system 108 including an imaging device 110 and an image generator 112 configured to capture the 2D images at the same scale. The imaging device 110 includes a camera configured to capture visible, infrared, or ultraviolet light. In some embodiments, the imaging device 110 is configured to capture one or more top-view images of the fashion product placed on the surface 114.

As shown in FIG. 1, the imaging device 110 is positioned at fixed 3-dimensional (3D) coordinates for all the images with respect to a surface 114. Further, the dimension of the surface 114 (such as length, width, and height) are predetermined and fixed for all the images captured by the imaging device 110. Moreover, the imaging device brand, make, model etc. are predetermined and fixed for all the images. Thus, all the images captured by the imaging device 110 for one or more fashion products are captured at the same scale.

The image generator 112 is communicatively coupled with the imaging device 110, and configured to receive the one or more images from the imaging device 110. The image generator 112 is further configured to generate one or more corresponding 2D images by applying one or more computer vision models to the one or more images. The image generator 112 is furthermore configured to store the 2D images and a corresponding fashion product identifier in the image database. The corresponding fashion product identifier may include the stock keeping identifier (sku id) of the fashion product, for example.

In some embodiments, the image generator 112 is configured to generate the one or more 2D images by applying one or more segmentation algorithms to the one or more images. In some embodiments, the image generator 112 is further configured to apply a foreground label or a background label to each pixel in the one or more 2D images, and remove the background by using an aggregate of the foreground labels or the background labels.

In some embodiments, the image generator 112 is further configured to apply an alpha mask to the 2D images to render them transparent. In some embodiments, the image generator may be configured to apply blending to the 2D images using an alpha mask. Alpha blending is the process of overlaying a foreground image with transparency over a background image. The transparency is often the fourth channel of an image (e.g., in a transparent PNG image), but it can also be a separate image. This transparency mask is often called the “alpha mask” or the “alpha matte”.

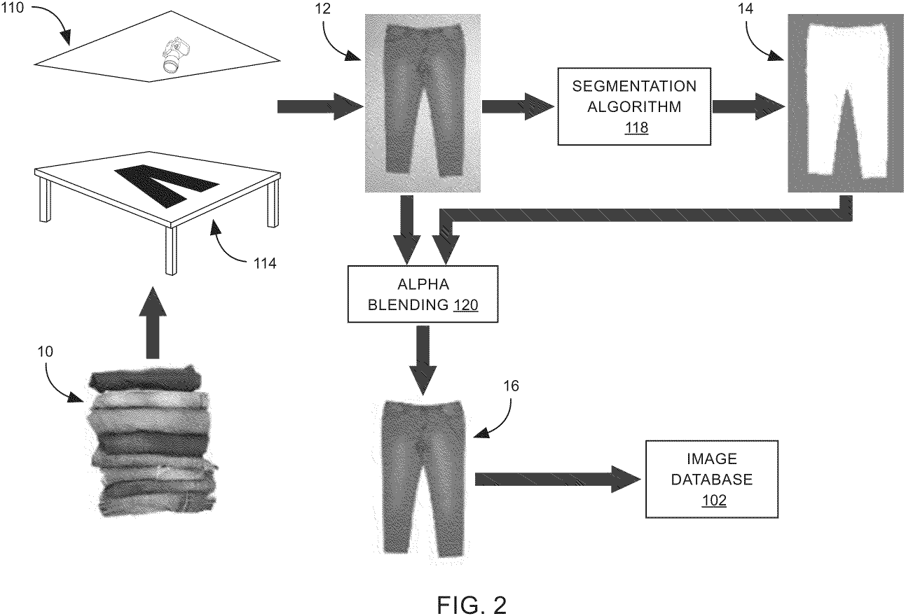

FIG. 2 illustrates an example workflow of 2D image generation according to embodiments of the present description. As shown in FIG. 2, the imaging device 110 is configured to capture an image of a trouser placed on top of the surface 114. The trouser is selected from a collection of trousers 10. The image generator (not shown in FIG. 2) is configured to receive the image 12 captured by the imaging device 110 and configured to apply a segmentation algorithm 118 to the image 12 to generate the segmented image 14. The image generator is further configured to apply alpha blending 120 to the image 12 and the segmented image 14 to generate the transparent 2D image 16. The image generator is further configured to store the 2D image in the image database 102.

Referring again to FIG. 1, the system 100 further includes a selection module 104 configured to allow a user to select a target fashion product and a reference fashion product. In some embodiments, as shown in FIG. 1, the selection module 104 is communicatively coupled with a user interface 116 of the e-commerce platform.

The term “target fashion product” as used herein refers to a product that the user is currently browsing and/or is interested in purchasing. The selection module 104 is configured to allow the user to select the target fashion product from a catalog of fashion products available on the online relation platform. The term “reference fashion product” as used herein refers to a product compared to which the user wants to visually compare the target fashion product. In some embodiments, the reference fashion product maybe another size of the same brand and/or style as the target fashion product. Thus, allowing the user to visually compare two different sizes of the same brand and/or style of the fashion product.

In some other embodiments, the reference fashion product may be a product for which the user is aware of the size and/or fit. The reference fashion product in such embodiments may be of the same or different brand and/or style as the target fashion product. The reference fashion product may be a product previously purchased by the user on the e-commerce platform itself or from another vendor (online or offline).

In such embodiments, the selection module 104 is configured to allow the user to select the reference fashion product based on a fashion product previously purchased by the user on the e-commerce platform or from another vendor (online or offline). In some embodiments, the selection module 104 is configured to allow the user to select the reference fashion product based on the purchase history of the user on the e-commerce platform. In another embodiment, the selection module 104 is configured to allow the user to select the reference fashion product from a product catalog based on the brand, style, size, etc. of the fashion product.

The selection module 104 is communicatively coupled with the comparison module 106 and configured to provide information (e.g., brand, style, size, SKU ID, and the like) corresponding to the target fashion product and the reference fashion product to the comparison module 106. The comparison module 106 is configured to access a 2D image of the target fashion product and a 2D image of the reference fashion product from the image database 102. As noted, earlier, the 2D images are captured at the same scale using an identical setup (i.e., identical imaging device and configuration, identical surface dimensions, and identical 3D coordinates of the imagine device with respect to the surface).

The comparison module 106 is further configured to allow the user to visually compare the target fashion product with the reference fashion product with respect to the one or more attributes by positioning the 2D image of the target fashion product on top or bottom of the 2D image of the reference fashion product. In some embodiments, the comparison module is configured to allow the user to visually compare the target fashion product with the reference fashion product via the user interface 116.

The comparison module 106 is further configured to allow the user to change a z-index of the target fashion product or the reference fashion product. The z-index determines whether the target fashion product or the reference fashion product is on the top or bottom. In some embodiments, the comparison module 106 is further configured to allow the user to select a background or a foreground image, thereby changing the z-index of the target fashion product or the reference fashion product

The comparison module 106 is further configured to allow the user to drag and change the relative position of the target fashion product and the reference fashion product with respect to each other in four directions (e.g., left, right, top, bottom). The comparison module 106 is moreover configured to allow the user to adjust relative position of the target fashion product and reference fashion product, thereby allowing for a plurality of visual comparisons pertaining to a plurality of size attributes of a fashion product. For example, a size pertaining to chest, waist, thigh, length, shoulder, and the like.

In some embodiments, the comparison module 106 is further configured to allows the user to select one or more markers on both the target fashion product and the reference fashion product, and align the two fashion products based on the one or more markers selected. For example, the comparison module 106 may allow the user to manually select one or more points on the shoulders of a target shirt and a reference shirt as one or more markers. The user may further align the target shirt and the reference shirt at the shoulders based on the one or more markers selected.

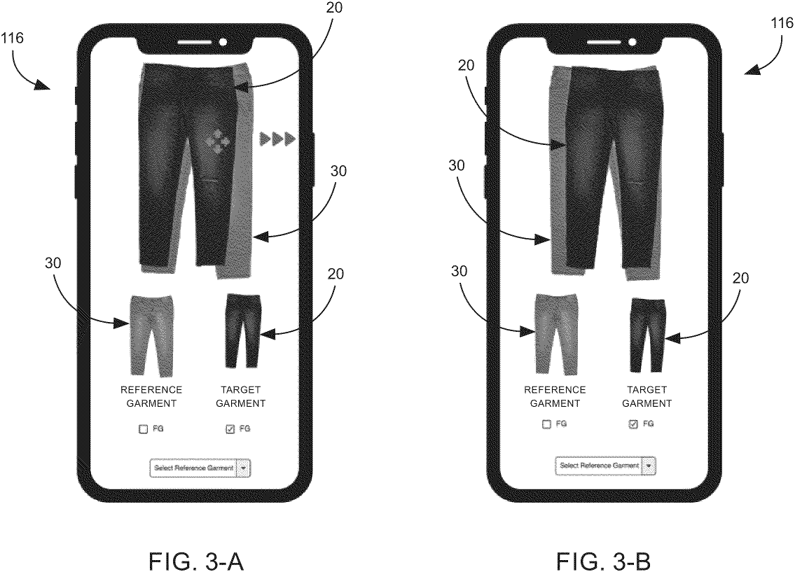

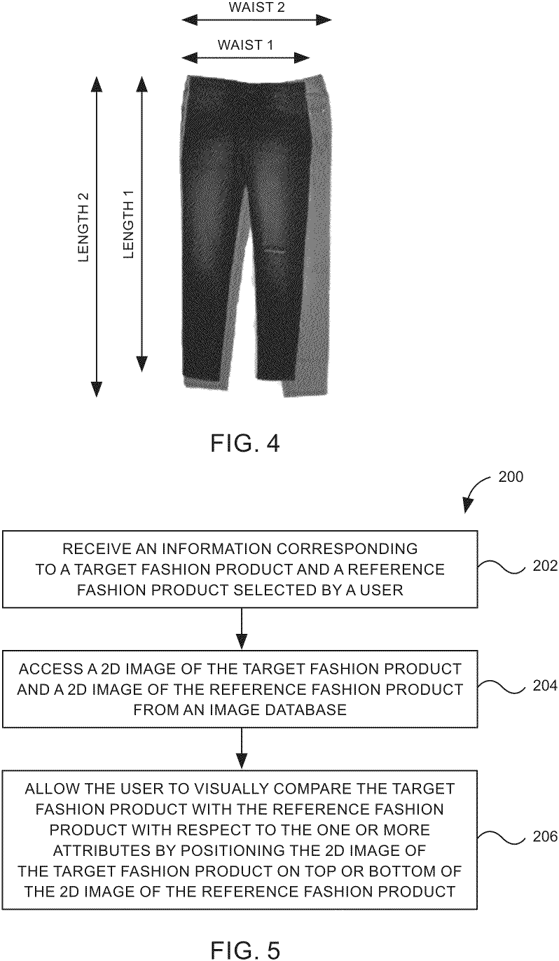

FIGS. 3A and 3B illustrate an example user interface 116 where the user is allowed to visually compare a target garment 20 with a reference garment 30 by positioning the 2D image of the target garment 20 on top or bottom of the 2D image of the reference garment 30. As shown in FIGS. 3A and 3B, the user interface 116 allows the user to select either the reference garment 30 or the target garment 20 as the foreground image (“FG” in FIGS. 3 and 3B). The user interface 116 further allows the user to move the 2D images of the target garment 20 in the four directions, thereby allowing visual comparison of the two garments. FIG. 4 illustrates an example where the user is able to compare the length and waist of the target fashion product 20 and the reference fashion product 30 visually using the techniques described herein.

The manner of implementation of the system 100 of FIG. 1 is described below in FIG. 5.

FIG. 5 is a flowchart illustrating a method 200 for visually comparing one or more attributes of two fashion products on an e-commerce platform. The one or more attributes include size and/or fit-related attributes of the fashion product. Non-limiting examples of size-related attributes include length, width, area, circumference, and the like. For garment-related fashion products, non-limiting examples of size-related attributes may include for example, length of the garment, length of a sleeve, waist size, width of a shoulder, length of an inseam, and the like.

The method 200 may be implemented using the systems of FIG. 1, according to some aspects of the present description. Each step of the method 200 is described in detail below.

The method 200 includes, at step 202, receiving an information corresponding to a target fashion product and a reference fashion product selected by a user. The terms “target fashion product” and “reference fashion product” have been defined herein earlier.

The method 200 further includes, at step 204, accessing a 2D image of the target fashion product and a 2D image of the reference fashion product from an image database comprising a plurality of two-dimensional (2D) images captured at the same scale for a plurality of fashion products. The 2D images are standalone images of the fashion product in one embodiment. In certain embodiments, the 2D images may be flat shot images of the fashion product. The flat shot images may be taken from any suitable angle and include top-views, side views, front-views, back-views, and the like. As noted, earlier, the 2D images are captured at the same scale using an identical setup (i.e., identical imaging device and configuration, identical surface dimensions, and identical 3D coordinates of the imagine device with respect to the surface).

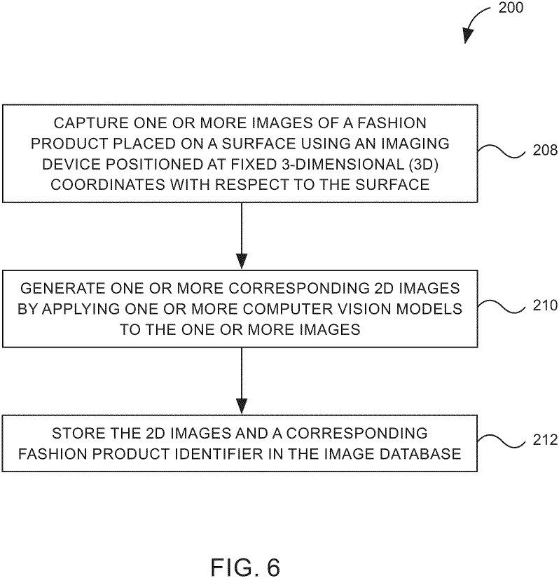

In some embodiments, as shown in FIG. 6, the method 200 further includes, at step 208, generating the plurality of 2D images by capturing one or more images of a fashion product placed on a surface using an imaging device positioned at fixed 3-dimensional (3D) coordinates with respect to the surface. At step 210, the method further includes generating one or more corresponding 2D images by applying one or more computer vision models to the one or more images. Moreover, the method includes, at step 212, storing the 2D images and a corresponding fashion product identifier in the image database.

In some embodiments, the method 200 further includes generating the one or more 2D images by applying one or more segmentation algorithms to the one or more images. In some embodiments, the method 200 further includes applying a foreground label or a background label to each pixel in the one or more 2D images, and removing the background by using an aggregate of the foreground labels or the background labels.

In some embodiments, the method 200 further includes applying an alpha mask to the 2D images to render them transparent. Alpha blending is the process of overlaying a foreground image with transparency over a background image. The transparency is often the fourth channel of an image (e.g., in a transparent PNG image), but it can also be a separate image. This transparency mask is often called the “alpha mask” or the “alpha matte”.

Referring again to FIG. 5, at step 206, the method further includes allowing the user to visually compare the target fashion product with the reference fashion product with respect to the one or more attributes by positioning the 2D image of the target fashion product on top or bottom of the 2D image of the reference fashion product.

The step of comparing the target fashion product and the reference fashion product further includes allowing the user to change a z-index of the target fashion product or the reference fashion product. The z-index determines whether the target fashion product or the reference fashion product is on the top or bottom. In some embodiments, the step 206 further includes allowing the user to select a background or a foreground image, thereby changing the z-index of the target fashion product or the reference fashion product.

The method 200 further includes, at step 206, allowing the user to drag and change the relative position of the target fashion product and the reference fashion product with respect to each other in four directions (e.g., left, right, top, bottom). The method 200 further includes allowing the user to adjust relative position of the target fashion product and reference fashion product, thereby allowing for a plurality of visual comparisons pertaining to a plurality of size attributes of a fashion product. For example, a size pertaining to chest, waist, thigh, length, shoulder, and the like.

In some embodiments, method 200 further includes, at step 206, allowing the user to select one or more markers on both the target fashion product and the reference fashion product, and aligning the two fashion products based on the one or more markers selected. For example, a user may manually select one or more points on shoulders of a target shirt and a reference shirt as one or more markers. The user may further align the target shirt and the reference shirt at the shoulders based on the one or more markers selected.

The system and methods described herein allow the users to get a relative sense of size and/or fit of the target fashion product by visually comparing against the reference fashion product. Thus, the system and methods describe herein allow the users to make a more informed decision on their purchase, thereby reducing size and/or fit-related returns and improved customer experience.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROMcassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

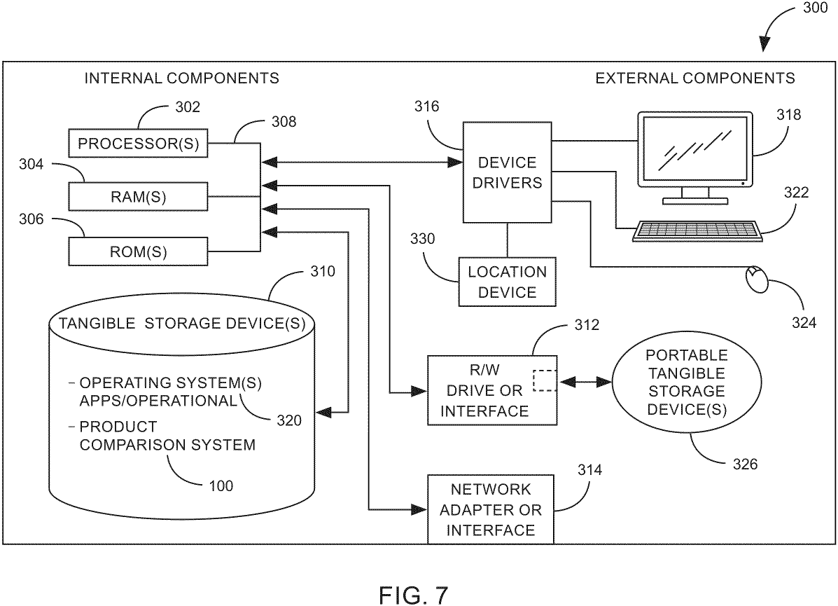

One example of a computing system 300 is described below in FIG. 7. The computing system 300 includes one or more processor 302, one or more computer-readable RAMs 304 and one or more computer-readable ROMs 306 on one or more buses 308. Further, the computer system 308 includes a tangible storage device 310 that may be used to execute operating systems 320 and product comparison system 100. Both, the operating system 320 and the product comparison system 100 are executed by processor 302 via one or more respective RAMs 303 (which typically includes cache memory). The execution of the operating system 320 and/or product comparison system 100 by the processor 302, configures the processor 302 as a special-purpose processor configured to carry out the functionalities of the operation system 320 and/or the product comparison system 100, as described above.

Examples of storage devices 310 include semiconductor storage devices such as ROM 503, EPROM, flash memory or any other computer-readable tangible storage device that may store a computer program and digital information.

Computing system 300 also includes a R/W drive or interface 312 to read from and write to one or more portable computer-readable tangible storage devices 326 such as a CD-ROM, DVD, memory stick or semiconductor storage device. Further, network adapters or interfaces 314 such as a TCP/IP adapter cards, wireless Wi-Fi interface cards, or 3G or 3G wireless interface cards or other wired or wireless communication links are also included in the computing system 300.

In one example embodiment, the product comparison system 100 may be stored in tangible storage device 310 and may be downloaded from an external computer via a network (for example, the Internet, a local area network, or another wide area network) and network adapter or interface 314.

Computing system 300 further includes device drivers 316 to interface with input and output devices. The input and output devices may include a computer display monitor 318, a keyboard 322, a keypad, a touch screen, a computer mouse 324, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for visually comparing one or more attributes of two fashion products on an e-commerce platform, the system comprising:
an image database comprising a plurality of two-dimensional (2D) images captured at the same scale for a plurality of fashion products;
a selection module configured to allow a user to select a target fashion product and a reference fashion product; and
a comparison module configured to:
access a 2D image of the target fashion product and a 2D image of the reference fashion product from the image database; and
allow the user to visually compare the target fashion product with the reference fashion product with respect to the one or more attributes by positioning the 2D image of the target fashion product on top or bottom of the 2D image of the reference fashion product.

2. The system of claim 1, further comprising an image processing system, comprising:
an imaging device positioned at fixed 3-dimensional (3D) coordinates with respect to a surface and configured to capture one or more images of a fashion product placed on the surface; and
an image generator configured to:
receive the one or more images from the imaging device,
generate one or more corresponding 2D images by applying one or more computer vision models to the one or more images, and
store the 2D images and a corresponding fashion product identifier in the image database.

3. The system of claim 2, wherein the image generator is configured to generate the one or more 2D images by applying one or more segmentation algorithms to the one or more images.

4. The system of claim 3, wherein the image generator is further configured to apply a foreground label or a background label to each pixel in the one or more 2D images, and remove the background by using an aggregate of the foreground labels or the background labels.

5. The system of claim 2, wherein the image generator is further configured to apply an alpha mask to the 2D images to render them transparent.

6. The system of claim 1, wherein the selection module is configured to allow the user to select the reference fashion product based on a fashion product previously purchased by the user on the e-commerce platform or from another vendor.

7. The system of claim 1, wherein the comparison module is further configured to allow the user to change a z-index of the target fashion product or the reference fashion product.

8. The system of claim 1, wherein the comparison module is further configured to allow the user to drag and change the relative position of the target fashion product and the reference fashion product with respect to each other in four directions.

9. The system of claim 1, wherein the comparison module is further configured to allow the user to select one or more markers on both the target fashion product and the reference fashion product, and align the two fashion products based on the one or more markers selected.

10. The system of claim 1, wherein the one or more attributes comprise size- or fit- related attributes of the fashion product.

11. A method for visually comparing one or more attributes of two fashion products on an e-commerce platform, the method comprising:
receiving an information corresponding to a target fashion product and a reference fashion product selected by a user;
accessing a 2D image of the target fashion product and a 2D image of the reference fashion product from an image database comprising a plurality of two-dimensional (2D) images captured at the same scale for a plurality of fashion products; and
allowing the user to visually compare the target fashion product with the reference fashion product with respect to the one or more attributes by positioning the 2D image of the target fashion product on top or bottom of the 2D image of the reference fashion product.

12. The method of claim 11, further comprising generating the plurality of 2D images by:
capturing one or more images of a fashion product placed on a surface using an imaging device positioned at fixed 3-dimensional (3D) coordinates with respect to the surface;
generating one or more corresponding 2D images by applying one or more computer vision models to the one or more images, and
storing the 2D images and a corresponding fashion product identifier in the image database.

13. The method of claim 12, wherein generating the one or more 2D images comprises applying one or more segmentation algorithms to the one or more images.

14. The method of claim 13, wherein the application of one or more segmentation algorithms comprises applying a foreground label or a background label to each pixel in an image, and removing the background by using an aggregate of the foreground labels or the background labels.

15. The method of claim 12, further comprising applying an alpha mask to the 2D images to render them transparent.

16. The method of claim 11, wherein the reference fashion product is selected based on a fashion product previously purchased by the user on the e-commerce platform or from another vendor.

17. The method of claim 11, wherein the step of comparing the target fashion product and the reference fashion product further comprises allowing the user to change a z-index of the target fashion product or the reference fashion product.

18. The method of claim 11, wherein the step of comparing the target fashion product and the reference fashion product further comprises allowing the user to drag and change the relative position of the target fashion product and the reference fashion product with respect to each other in four directions.

19. The method of claim 11, wherein the step of comparing the target fashion product and the reference fashion product further comprises allowing the user to select one or more markers on both the target fashion product and the reference fashion product, and aligning the target fashion product and the reference fashion product based on the one or more markers selected.

20. The method of claim 11, wherein the one or more attributes comprise size or fit-related attributes of the fashion product.
